(19) United States
(12) Patent Application Publication
(10) Pub. No.: US 2021/0016173 A1
(43) Pub. Date: Jan. 21, 2021

(54) GAME MACHINE

(71) Applicant: DYNAM JAPAN HOLDINGS CO., LTD., Tokyo (JP)

(72) Inventor: Tatsuhiro KOGA, Tokyo (JP)

(21) Appl. No.: 16/958,872

(22) PCT Filed: Dec. 27, 2017
(86) PCT No.: PCT/JP2017/046899

§ 371 Date: Sep. 18, 2020

(51) Int. Cl. A63F 13/537; A63F 13/812; G07F 17/32

(52) U.S. Cl. CPC A63F 13/537; A63F 7/022; G07F 17/3286; A63F 13/812

(57) ABSTRACT

The objective of the present invention is to provide a game machine employing computer simulation. This game machine is provided with a display device in a casing, and includes a game processing unit which executes a game process, and a consumption information processing unit which causes the display device to display consumption information relating to a game.

### TECHNICAL FIELD

The present invention relates to a game machine by computer simulation.

### BACKGROUND ART

In Japan, pachinko is a popular leisure activity among some lovers. In pachinko, by rotating a handle provided in the pachinko machine in a predetermined direction, a gaming ball (pachinko ball), which is a steel ball borrowed from the store with fee, is shot onto the board surface on which many nails have been struck. A predetermined number of prize balls (pachinko balls) can be obtained if a game ball that falls while colliding with a nail or the like on the board enters a specific winning opening. On the other hand, when the game ball does not enter the winning opening and reaches the lower end of the board surface, the game ball enters the out opening provided at the lower end of the board surface and is collected. Both the game ball and the prize ball are pachinko balls. The pachinko ball that is thrown out on the board is the game ball and the pachinko ball obtained as a result of the game ball entering the winning opening is the prize ball. The prize ball can be used as a game ball. Therefore, the player can enjoy playing pachinko for a long time because the player can increase the number of game balls in the player's possession by inserting the game balls into the winning opening.

With regard to such pachinko, conventionally, there is known a game machine (hereinafter, referred to as “digital pachinko” for the convenience of explanation) in which computer simulations have been used to realize the operation of the pachinko machine so that it can be played with a sensation similar to that of an actual pachinko machine, and is proposed in, for example, Patent Literatures 1 to 8 below.

The digital pachinko machines of Patent Literatures 1 to 5 are made by realizing a conventional mechanical pachinko machine by computer simulation using a display device such as a CRT or a liquid crystal. So, they are no more than the conventional mechanical pachinko machines simply digitized.

In the digital pachinko of Patent Literatures 6 to 8, when a predetermined event occurs, effects to change the positions and sizes of the starting opening and the winning opening on the board displayed by the display device, the arrangement of the nails, and the shape and color of the game balls and the like, are made.

### CITATION LIST

### Patent Literature

Patent Literature 1: JP 57-60680 U

Patent Literature 2: JP 60-75072 A

Patent Literature 3: JP 6-254215 A

Patent Literature 4: JP 10-57561 A

Patent Literature 5: JP 11-128446 A

Patent Literature 6: JP 2003-220187 A

Patent Literature 7: JP 2003-225465 A

Patent Literature 8: JP 2005-288031 A

### SUMMARY OF INVENTION

### Technical Problem

A game machine such as a digital pachinko can be realized by using the description of each of the above Patent Literatures. However, when a player plays a game with a game machine such as a digital pachinko, it may not be known how much money is consumed. Especially when playing the game with the game machine for the first time, there is anxiety because the consumption amount is unknown. Therefore, there is a psychological resistance to playing a game with a new game machine. In particular, in recent years, excessive dependence on games such as pachinko has become a social problem, and players, especially those who are trying to play new games, are very psychologically anxious about money consumption.

Such anxiety is the same not only in digital pachinko but also in realizing a slot machine by computer simulation or in a casino machine installed in a casino.

### Solution to Problem

In view of the above problems, the present inventor has invented a game machine that can eliminate the anxiety about money consumption when playing with a game machine.

A first aspect of the invention is a game machine having a display device in a casing, and the game machine includes a game processing unit that performs a game process, and a consumption information processing unit that displays consumption information for the game on the display device.

By forming the invention as above, consumption information for a game can be displayed. Therefore, when playing a game on a game machine, the player can eliminate the anxiety about money consumption by visually recognizing the consumption information.

In the above invention, the consumption information processing unit may be configured like a game machine that calculates maximum consumption information per unit time and displays the maximum consumption information on the display device.

A value calculated as in the invention can be used as the consumption information.

In the above invention, the consumption information processing unit may be configured like a game machine that calculates the maximum consumption information per unit time using a maximum number of virtual game balls that can be fired per unit time and an exchange rate.

The maximum consumption information per unit time can be calculated as in the invention.

In the above invention, the consumption information processing unit may be configured like a game machine that calculates the maximum consumption information based on a past performance, and displays the maximum consumption information on the display device.

As the consumption information, like the invention, by calculating the maximum consumption information based on the past performance, the maximum consumption information according to a player's game can be displayed, and each player's game characteristics (playing games slowly or quickly) may be reflected.

In the above invention, the consumption information processing unit may be configured like a game machine that calculates the maximum consumption information by specifying a maximum consumption point of virtual game balls per continuous unit time from a record of the number of fired virtual game balls in a predetermined time among ball information records in the game machine.

The maximum consumption information based on the past performance may be calculated as in the invention.

In the above invention, the consumption information processing unit may be configured like a game machine that receives the maximum consumption information selected or input by a player and displays the maximum consumption information on the display device.

The maximum consumption information may be set by the player.

In the above invention, the game machine may be configured like a game machine that includes a warning processing unit that performs a predetermined control process when a predetermined condition for the consumption information is satisfied.

The player may focus on the game and not be aware of the consumption information by simply displaying the consumption information. Therefore, by executing a predetermined control process, it is possible to bring the player's attention to the consumption information.

In the above invention, the warning processing unit may be configured like a game machine that displays a warning message on the display device as the predetermined control process.

By displaying a warning message as a control process, it is possible to call the player's attention to the consumption information.

In the above invention, a plurality of thresholds is provided and when an amount or credit in the game machine satisfies a condition for each threshold, the warning processing unit may be configured like a game machine that displays a different warning message on the display device as the predetermined control process.

Regarding the relationship between the amount or the credit and the consumption information, it becomes easier to draw the player's attention to the consumption information by issuing different warning messages depending on the stage.

In the above invention, the warning processing unit may be configured like a game machine that stops a game in the game machine as the predetermined control process.

There are some players who cannot stop playing the game only with the warning message. Therefore, the game may be forcibly stopped. As a result, the game is surely stopped, so that the player does not spend money anymore and the anxiety about money can be eliminated.

In the above invention, the game machine may be configured like a game machine that includes an available game time calculation processing unit that displays an available game time according to an amount or credit of the player.

By displaying the available game time, the player can recognize how much more time the player can enjoy the game. Therefore, the pace of the game can be adjusted by the player, and the anxiety about money can be eliminated.

In the above invention, the available game time calculation processing unit may be configured like a game machine that calculates an available game time using a maximum number of virtual game balls that can be fired per unit time, an exchange rate, and an amount.

In the above invention, the available game time calculation processing unit may be configured like a game machine that calculates an available game time using a ball payout ratio, a maximum number of virtual game balls that can be fired per unit time, an exchange rate, and an amount.

The available game time can be calculated as in these inventions.

In the above invention, the game machine may be configured like a game machine that changes the exchange rate using maximum consumption information when the available game time calculated by the available game time calculation processing unit satisfies a predetermined condition for the available game time.

When the game progresses at a faster pace than the player desires, the player cannot enjoy the game without inputting additional money until a game time that the player desires to play. Therefore, the progress of the game at a fast pace leads the player to worry about money consumption. Therefore, by changing the exchange rate, the pace of money consumption of the player can be suppressed, and the player's anxiety about money consumption can be eliminated. In addition, the player can enjoy the game until the desired game time.

In the above invention, when consumption information per predetermined unit time satisfies a predetermined condition, the game processing unit may be configured like a game machine that changes a firing speed of a virtual game ball so as not to exceed the consumption information in the consumption information processing unit.

When the game progresses at a faster pace than the player desires, the player cannot enjoy the game without inputting additional money until a game time that the player desires to play. Therefore, the progress of the game at a fast pace leads the player to worry about money consumption. Therefore, by changing the firing speed of the virtual game ball, the pace of the game can be changed, and the player's anxiety about money consumption can be eliminated. In addition, the player can enjoy the game until the desired game time.

In the above invention, when a base satisfies a predetermined condition, the game processing unit may be configured like a game machine that changes a base setting so as not to exceed the consumption information in the consumption information processing unit.

When the game progresses at a faster pace than the player desires, the player cannot enjoy the game without inputting additional money until a game time that the player desires to play. Therefore, the progress of the game at a fast pace leads the player to worry about money consumption. Therefore, by changing the base, the payout of balls in the game can be changed, and the player's anxiety about money consumption can be eliminated. In addition, the player can enjoy the game until the desired game time.

### Advantageous Effects of Invention

With the game machine of the invention, it is possible to eliminate anxiety about money consumption when a player plays a game on the game machine.

### BRIEF DESCRIPTION OF DRAWINGS

FIG. 1 is a diagram schematically illustrating an example of an external appearance of a game machine of the invention.

FIG. 2 is a diagram schematically illustrating an example of the structure of a control device provided in the game machine of the invention.

FIG. 3 is a diagram schematically illustrating an example of processing functions of the control device provided in the game machine of the invention.

FIG. 4 is a flowchart illustrating an example of a process before, at the end of, etc. a game in the game machine of the invention.

FIG. 5 is a flowchart illustrating an example of a game process in the game machine of the invention.

FIG. 6 is a flowchart illustrating an example of a remaining ball return process in the game machine of the invention.

FIG. 7 is a flowchart illustrating an example of a consumption amount calculation process in the game machine of the invention.

FIG. 8 is a flowchart illustrating an example of a rate calculation process in the game machine of the invention.

FIG. 9 is a flowchart illustrating an example of a warning processing in the game machine of the invention.

FIG. 10 is a flowchart illustrating an example of an automatic rate change process in the game machine of the invention.

FIG. 11 is a flowchart illustrating an example of a firing speed adjustment process in the game machine of the invention.

FIG. 12 is a flowchart illustrating an example of a base adjustment process in the game machine of the invention.

FIG. 13 is a diagram schematically illustrating an example of a screen displayed by a game processing unit on a display device.

FIG. 14 is a diagram schematically illustrating a state in which virtual game balls are moving from the upper side to the lower side of a virtual board.

FIG. 15 is a diagram schematically illustrating a state immediately before a virtual game ball enters a virtual winning opening.

FIG. 16 is a diagram schematically illustrating a state immediately after the virtual game ball enters the virtual winning opening.

FIG. 17 is a diagram schematically illustrating an example of processing functions of the control device included in the game machine of a fourth embodiment.

FIG. 18 is a diagram illustrating an example of a warning message according to the fourth embodiment.

FIG. 19 is a diagram illustrating another example of the warning message according to the fourth embodiment.

FIG. 20 is a diagram illustrating another example of the warning message according to the fourth embodiment.

FIG. 21 is a diagram illustrating another example of the warning message according to the fourth embodiment.

FIG. 22 is a diagram schematically illustrating an example of processing functions of a control device included in the game machine of a fifth embodiment.

### DESCRIPTION OF EMBODIMENTS

A game machine of the invention includes, in addition to digital pachinko machines, game machines in which slot machines are realized by computer simulation, and various casino machines installed in casinos. In the following description, the case of a digital pachinko machine as a game machine will be described, but the process thereof can be similarly realized in other types of game machines.

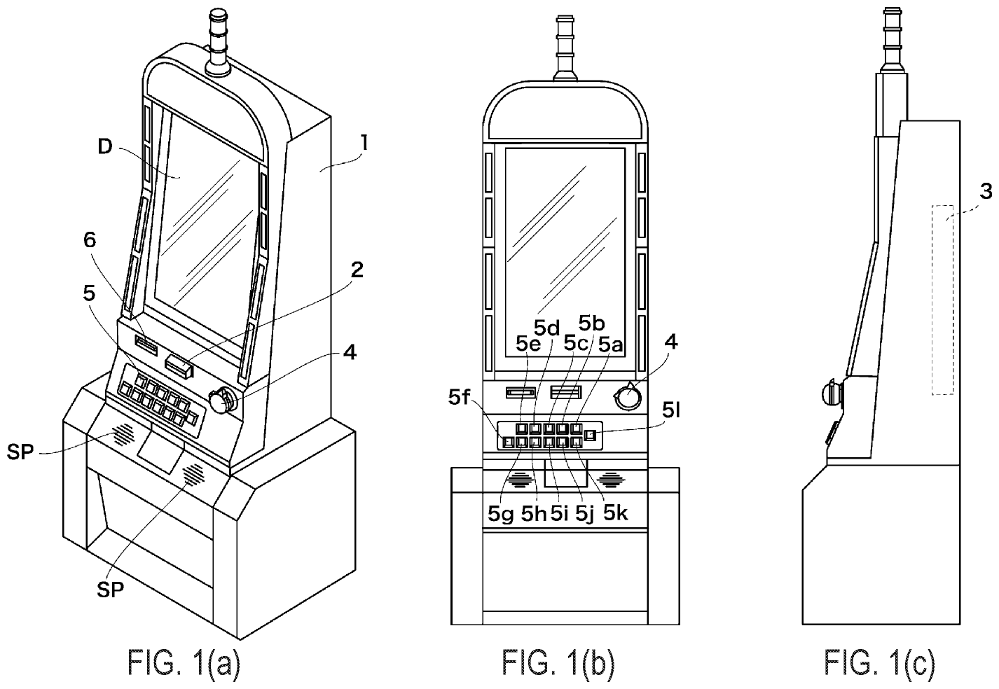

An example of the appearance of the digital pachinko machine as a game machine is schematically illustrated in FIG. 1. FIG. 1(a) is a perspective view of the game machine of the invention, FIG. 1(b) is a front view of the game machine, and FIG. 1(c) is a side view of the game machine. The game machine is a digital pachinko machine that realizes a pachinko machine by displaying the board of a mechanical pachinko machine by computer simulation, and includes at least a display device D, a speaker SP, and a handle 4 in a casing 1. The display device D displays a virtual board 201 imitating the board surface of a mechanical pachinko machine and various kinds of information necessary for playing pachinko. As the display device D, an appropriate display device D such as a liquid crystal display and an organic EL display can be used. The speaker SP is a device that outputs sound. The handle 4 is an input device for firing a virtual game ball 208 that moves on the virtual board 201 displayed on the display device D, and the firing speed of the virtual game ball 208 can be adjusted based on a rotation angle by rotating the handle 4 to a predetermined direction. The input device for firing the virtual game ball 208 is preferably the handle 4 because it evokes the sensation of a mechanical pachinko machine, but is not limited thereto. Examples of the input device may include a button, a lever, a dial, or a slide type knob.

The display device D is disposed on around the center to the upper side of the casing 1, and the speaker SP is disposed on the lower side of the display device D. Further, between the display device D and the speaker SP, there are provided an amount calculation device 2, the handle 4 as an input device, a button unit 5 for performing various input operations, and a ticket printer 6 for printing a ticket.

In FIG. 1, the amount calculation device 2 illustrates the case of a banknote slot for a player to borrow or purchase the virtual game ball 208, but a coin slot (token slot) may also be provided. In addition, a ticket reader may be provided to read information regarding the amount of money not consumed when playing a game on a game machine in the past. Banknotes inserted from the banknote slot and coins input from the coin slot are exchanged for the virtual game ball 208 at a rate selected by rate selection buttons 5a to 5d described later. For example, when one virtual game ball 208 is HK$0.2 and a HK$1,000 banknote is inserted from the banknote slot of the amount calculation device 2, the HK$1,000 banknote is exchanged for 5,000 virtual game balls 208. On the other hand, when one virtual game ball 208 is HK$1.0 and a HK$1,000 banknote is inserted from the banknote slot of the amount calculation device 2, the HK$1,000 banknote is exchanged for 1,000 virtual game balls 208. In this specification, the number of virtual game balls 208 that the player has will be referred to as “credit”, and the amount of money not consumed (the amount held) will be referred to as “amount”.

When the amount calculation device 2 has a ticket reader, for example, a predetermined ticket is encoded and printed with information corresponding to the amount of money held by the player, and is read by an infrared reading device such as a bar code reader, so that the money input or inserted by the player is reflected into the amount. Further, the ticket may be a paper and the information regarding the amount of money may be encoded and printed thereon. Alternatively, the ticket may be recorded as electronic information on a mobile phone, an IC card, or the like, and the information may be read by a ticket reader. For example, the encoded information regarding the amount of money (amount) may be displayed on the mobile phone and read by a ticket reader, or the information regarding the amount of money may be stored in an IC memory of the mobile phone or the IC card, and the ticket reader may acquire the information through short-range wireless communication with the IC memory in a contact or non-contact manner. The banknote slot may have the function of a ticket reader.

Instead of the information corresponding to the amount of money (amount), information regarding the number of virtual game balls 208 may be encoded in the ticket. In this case, if the exchange rate of the virtual game ball 208 for the amount of money is single, the information regarding the number of virtual game balls 208 may be read and directly reflected in the amount and credits. If there are multiple exchange rates, the selected exchange rate is also encoded. In this case, based on the number of virtual game balls 208 and the selected exchange rate, the information may be converted to an amount and reflected in the amount, and may be reflected in the number of virtual game balls 208. Further, the amount may be automatically set by the number of balls and the exchange rate read from the ticket.

The casing 1 has a button unit 5 to allow various input operations. The buttons 5a to 5d in the button unit 5 function as the rate selection buttons 5a to 5d for selecting a rate. The rate selection buttons 5a to 5d are devices that receive the selection of the exchange rate of the virtual game ball 208 to be exchanged based on the input coins and the inserted banknotes by the amount calculation device 2. For example, the rate selection buttons 5a to 5d are four buttons, and the exchange rate can be changed by pressing a predetermined button. For example, if the rate selection button 5a is pressed, the exchange rate is set to HK$0.2 per ball, if the rate selection button 5b is pressed, the rate is HK$0.6 per ball, if the rate selection button 5c is pressed, the rate is HK$1.0 per ball, and if the rate selection button 5d is pressed, the rate is HK$2.0 per ball. As the rate selection unit for performing rate selection, a switch or various input devices can be used in addition to the button.

In addition, as other buttons of the button unit 5, there are a button 5e for selecting a language, a button 5f for outputting a ticket from the ticket printer 6, a button 5g for adjusting the volume, a button 5h for displaying a game explanation screen, and a button 5i for displaying a tutorial. In addition, there are spare buttons 5j and 5k, and a button 5l for calling an employee in the store. The arrangement of the button unit 5 is not limited to this, and can be set arbitrarily. In addition, some buttons 5 may be omitted.

Inside the casing 1, there is provided a control device 3 that executes various control processes related to digital pachinko.

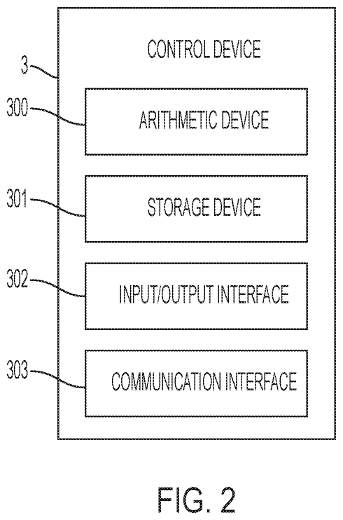

The hardware configuration of the control device 3 is illustrated in FIG. 2. The control device 3 includes an arithmetic device 300, a storage device 301, an input/output interface 302, a communication interface 303, and the like. The arithmetic device 300 corresponds to a CPU or the like that executes arithmetic processing of a program. The storage device 301 corresponds to a memory that stores information, and the arithmetic device 300 executes the process while reading and writing various information stored in the storage device 301. The input/output interface 302 is an interface with a device that outputs some information to the player, such as the display device D, the speaker SP, and the ticket printer 6 described above. The communication interface 303 is an interface with a communication device (not illustrated) when the game machine transmits/receives information to/from another computer, for example, a computer installed in a pachinko hall (pachinko parlor) or a casino hall, or another game machine. The information to be transmitted/received is, for example, information regarding sales in game machines.

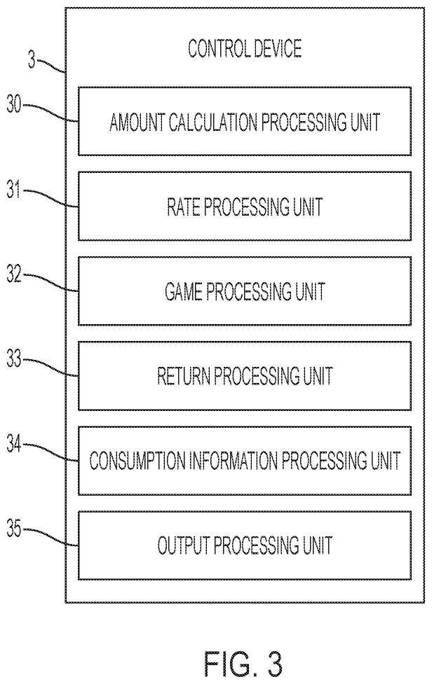

The configuration of each function in the control device 3 is illustrated in FIG. 3. The control device 3 includes an amount calculation processing unit 30, a rate processing unit 31, a game processing unit 32, a return processing unit 33, a consumption information processing unit 34, and an output processing unit 35 for executing the control process of the digital pachinko.

The amount calculation processing unit 30 calculates the amount based on the information of the amount of money input or inserted on the basis of the coin input into the coin slot and the banknote inserted into the banknote slot, which is specified in the amount calculation device 2. The currency used for the amount may be any currency.

The rate processing unit 31 receives information on the exchange rate of the virtual game ball 208 selected by the rate selection buttons 5a to 5d which form a rate selection unit. The exchange rate can be set appropriately.

The game processing unit 32 executes a process of a game by computer simulation in the game machine. For example, when the game is pachinko, a process for computer simulation of a mechanical pachinko machine is executed. In the game processing unit 32 of the invention, a case of realizing the board of the mechanical pachinko machine by computer simulation will be described, but there may be two types of execution modes such as a regular game (normal time) and a tulip game (jackpot). If the game is other than a pachinko game, a process of realizing each game by computer simulation only has to be executed.

The regular game (normal time) is a game mode for shifting to the tulip game (jackpot), and shifts to the tulip game when the virtual game ball 208 wins a first virtual winning opening 205. The tulip game is a game mode for winning prize balls, and when the virtual game ball 208 enters a second virtual winning opening 205, the player is able to obtain the prize balls and/or the corresponding credit or amount.

Further, the game processing unit 32 calculates the number of virtual game balls (credits) 208 based on the amount information calculated by the amount calculation processing unit 30 and the exchange rate information received by the rate processing unit 31. For example, when the exchange rate information of HK$0.2/ball is selected by the rate selection unit (rate selection buttons 5a to 5d) and the amount is HK$1,000, the game processing unit 32 calculates 5,000 balls as the number of virtual game balls 208. If there are balls already held and an amount is newly added, the stored number of virtual game balls 208 is added to the number of virtual game balls 208 to be calculated and added on the basis of the added amount and the exchange rate so as to newly calculate the number of virtual game balls 208 (the number of balls held). If the rate selection buttons 5a to 5d, which form a rate selection unit, are selected in the middle of the regular game or the tulip game, the number of balls held is calculated and changed on the basis of the exchange rate of the selected rate according to the amount at that time.

In the game processing unit 32, when the mechanical pachinko machine is realized by computer simulation, there are displayed the virtual board 201, an arbitrary number of virtual nails 203 (which are virtual representations of nails physically located on the board of the mechanical pachinko machine) for changing the moving path of the virtual game ball 208, virtual windmills 204 (which are virtual representations of windmills physically located on the board of the mechanical pachinko machine), at least one or more virtual winning openings 205, and the virtual out opening 206 on the display device D. One or more virtual winning openings 205 may be displayed. In addition, when the virtual game ball 208 enters into the virtual winning opening 205, the number of virtual game balls 208 set in the virtual winning opening 205 can be obtained as prize balls.

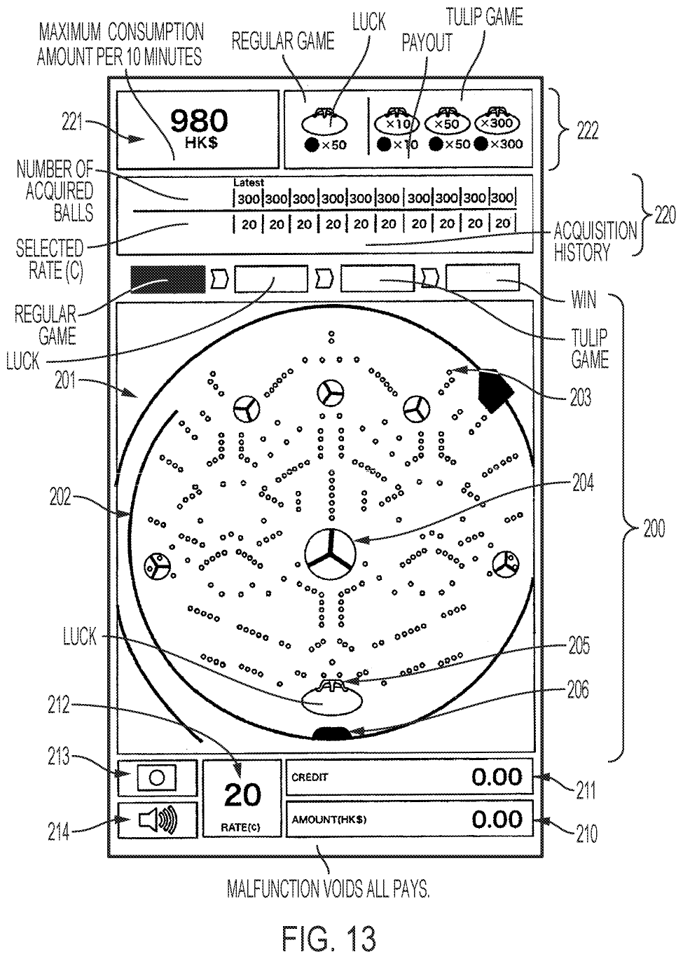

FIG. 13 schematically illustrates an example of a screen displayed on the display device D by the game processing unit 32. In the screen of FIG. 13, a game region 200, an amount display region 210, a credit display region 211, a selected rate display region 212, a selected language display region 213, a sound output selection region 214, an acquisition history display region 220, a consumption information display region 221, and a payout display region 222 are displayed.

The game region 200 is a region for playing a game with digital pachinko, and the game region 200 is used to display a virtual board 201, a virtual rail 202, virtual nails 203, virtual windmills 204, a virtual winning opening 205, and a virtual out opening 206 for playing digital pachinko. The amount display region 210 is a region for displaying the amount calculated by the amount calculation processing unit 30. The credit display region 211 is a region for displaying the credit, which is the number of virtual game balls 208 held, calculated by the game processing unit 32 based on the amount and the exchange rate. The selected rate display region 212 is a region for displaying the exchange rate between the amount and the virtual game ball 208 selected by the rate selection buttons 5a to 5d and received by the rate processing unit 31. In the selected language display region 213, the language used for display on the display device D is displayed. The language used for display can be switched by any method, and the language may be changed in order in response to, for example, pressing the button 5e. Examples of selectable languages include Japanese, English, Chinese (Mandarin, Cantonese), and Portuguese. The sound output selection region 214 is a region for visualizing and displaying the volume of the speaker SP provided in the casing 1. For example, each time the button 5g is pressed, the volume is switched sequentially in three stages of low, medium, and high, and 1, 2 and 3 curved bars of a volume icon in the sound output selection region 214 sequentially light up depending on each stage.

The acquisition history display region 220 is a region for displaying a history of the number of virtual game balls 208 acquired as prize balls as a result of playing digital pachinko and information on the exchange rate selected at that time.

The consumption information display region 221 is a region for displaying an amount or a credit calculated by a consumption information processing unit 34 described later. Further, the consumption information display region 221 may have a different display mode in which the amount or credit set as a consumable amount or credit in a certain period of time is displayed. In this case, the game processing unit 32 starts counting time at the start of the game, monitors the time and the amount or credit consumed, and determines whether the amount or credit set for a certain period of time has been exceeded. When the amount or credit is exceeded, control such as stopping the game is performed. The consumable amount or credit in a certain period of time may be input by the player, may be preset by the store, or may be initially set by the game machine.

The payout display region 222 is a region for displaying the number of virtual game balls 208 that can be obtained as prize balls (payout) by the virtual game balls 208 entering the virtual winning opening 205.

The game processing unit 32 determines the firing speed of the virtual game ball 208 by detecting the rotation angle by rotating the handle 4 of the game machine, and fires the virtual game ball 208. When the virtual game ball 208 is fired on the virtual board 201, the number of possessed balls is decremented by 1, and the number of possessed balls displayed in the credit display region 211 is decreased by 1. In addition, the amount displayed in the amount display region 210 is subtracted and displayed according to the virtual game ball 208 that has been fired. For example, when the exchange rate is HK$0.2 and the amount is HK$1,000, the amount of HK$0.2 is subtracted from the amount by firing one virtual game ball 208, which is displayed as HK$999.80.

The virtual game ball 208 moves along the virtual rail 202 based on the determined firing speed, and moves so as to fall along the virtual board 201 from above to below. The movement of the virtual game ball 208 on the virtual board 201 can be realized by calculating the position coordinates of the virtual game ball 208 on the virtual board 201 based on a known calculation formula. When the virtual game ball collides with the virtual nails 203, the virtual windmills 204 or the like (the position coordinates of the virtual game ball 208 are within a predetermined range from the position coordinates of the virtual nail 203 or the virtual windmill 204), the virtual game ball 208 reflects and moves, and the moving direction is changed. The reflection and the moving direction changing process of the virtual game ball 208 when the virtual game ball 208 collides with the virtual nail 203, the virtual windmill 204, or the like can be calculated by a known calculation formula.

The virtual game ball 208 enters the virtual winning opening 205 while moving from above to below of the virtual board 201 displayed on the display device D (the position coordinates of the virtual game ball 208 are within a predetermined range from the position coordinates of the virtual winning opening 205). Then, the game processing unit 32 gives prize balls since the virtual game ball 208 has won the virtual winning opening 205. That is, the game processing unit 32 adds and stores the number of virtual game balls 208 acquired as prize balls to the number of possessed balls displayed in the credit display region 211. Further, the game processing unit 32 adds the amount obtained by multiplying the number of virtual game balls 208 obtained as prize balls by the exchange rate to the amount displayed in the amount display region 210, and stores the added amount. For example, when the exchange rate is HK$0.2, the amount is HK$1,000, and the number of the virtual game balls 208 won as prize balls is 50, the HK$0.2 is multiplied by 50 and added to the HK$1,000. That is, HK$1,010 is remembered as a new amount.

Although FIG. 13 illustrates a case where there is one virtual winning opening 205 on the virtual board 201, when there are a plurality of virtual winning openings 205 on the virtual board 201, the number of prize balls (virtual game balls 208) awarded by winning each virtual winning opening 205 may be the same or different. The number of prize balls (virtual game balls 208) provided by winning the virtual winning opening 205 can be set arbitrarily. The number of virtual winning openings 205 can also be set arbitrarily.

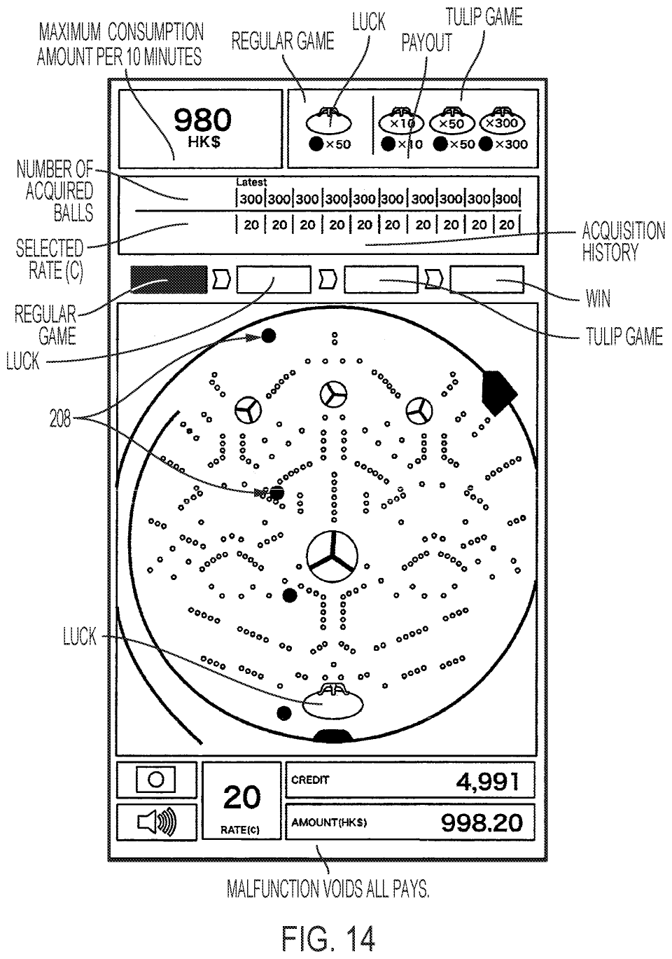

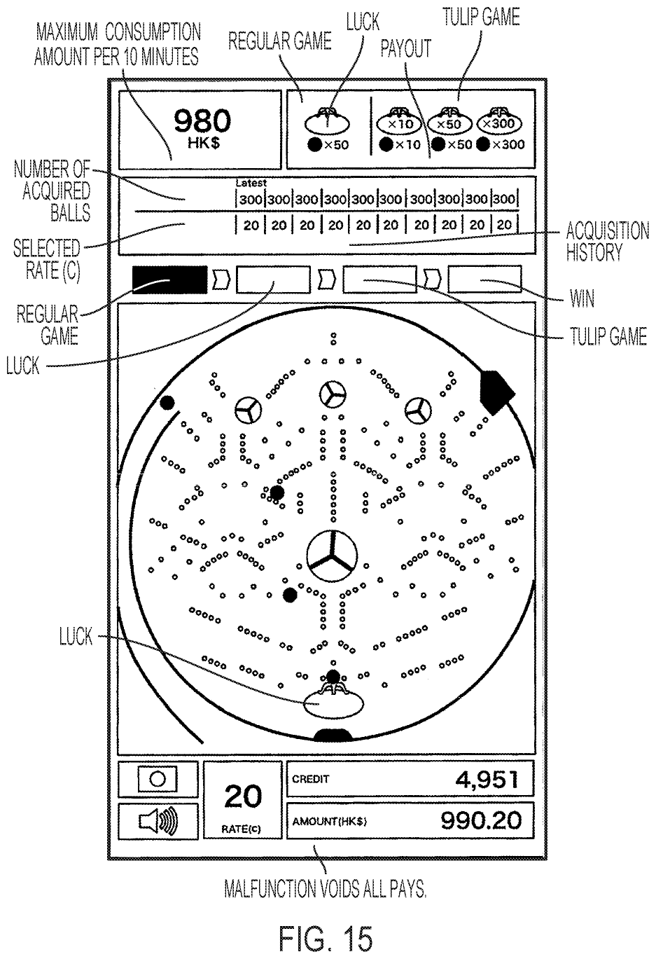

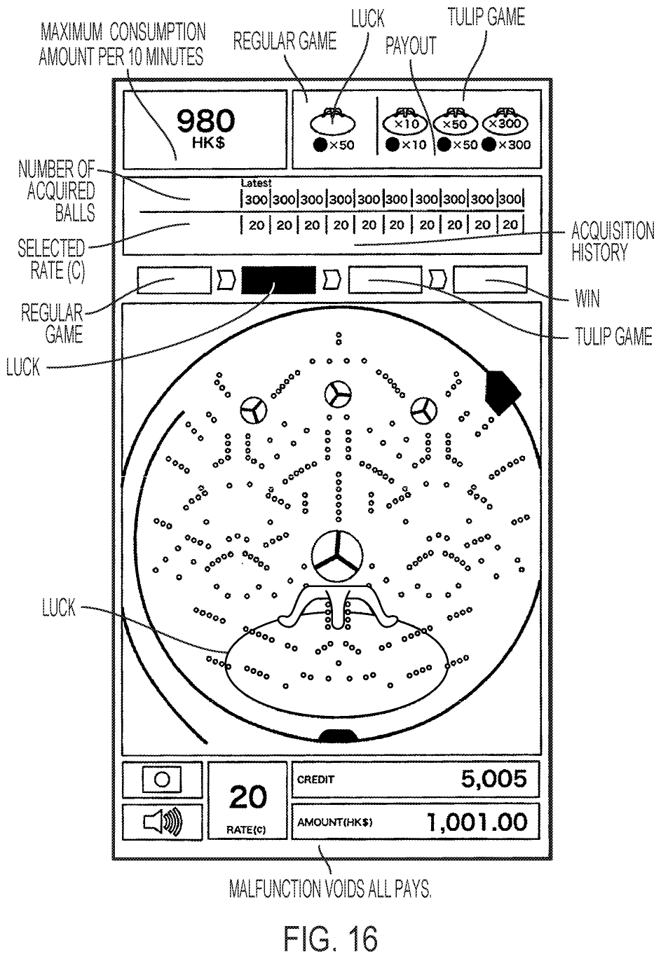

When the virtual game ball 208 reaches the lower side of the virtual board 201 without entering the virtual winning opening 205, the virtual game ball 208 moves to the virtual out opening 206 as it is, and the virtual game ball 208 is erased from the virtual board 201 and collected. FIG. 14 schematically illustrates a state in which the virtual game ball 208 is moving on the virtual board 201 from above to below. Further, FIG. 15 schematically illustrates a state immediately before the virtual game ball 208 enters the virtual winning opening 205. FIG. 16 schematically illustrates a state immediately after the virtual game ball 208 enters the virtual winning opening 205.

When the virtual game ball 208 enters the virtual winning opening 205, the return processing unit 33 determines the number of virtual game balls 208 remaining on the virtual board 201 (remaining balls), and adds the determined number to the number of possessed balls which is displayed in the credit display region 211. Further, the return processing unit 33 calculates the amount corresponding to the determined number of remaining balls and adds the amount corresponding to the determined number to the amount displayed in the amount display region 210. That is, the amount obtained by multiplying the determined number of remaining balls by the exchange rate is added to the amount displayed in the amount display region 210 to be updated. When the virtual game ball 208 enters the virtual winning opening 205, the virtual game ball 208 (remaining ball) is once erased from the virtual board 201 in order to perform a predetermined effect or the like, but the erasing is disadvantageous to the player. Therefore, in order to prevent the virtual game ball 208 from being erased, the player waits until the virtual game ball 208 fired on the virtual board 201 enters the virtual winning opening 205 or the virtual out opening 206, and then hits the next virtual game ball 208. Then, since the virtual game ball 208 is hit one by one, the consumption speed of the virtual game ball 208 becomes slow. This means that the consumption is reduced for the store where the game machine is installed, so the management efficiency deteriorates and it is not in a favorable state. Therefore, it is preferable for the store to have the next virtual game ball 208 fired, that is, have the virtual game balls 208 continuously fired in a state where the previously fired virtual game ball 208 remains on the virtual board 201. Therefore, in order to obtain the effect, a process of returning the remaining balls and the corresponding credit or amount at the time of winning by the return processing unit 33 is provided.

The consumption information processing unit 34 calculates the consumption amount or the number of consumed balls (collectively referred to as “consumption information”) displayed in the consumption information display region 221. There are various methods for calculating consumption information. In the description of the invention, the case of the consumption amount as the consumption information will be described, but in the case of the number of consumed balls, the same process can be performed if a process of calculating the consumption amount and the exchange rate is performed in an arithmetic manner.

The first calculation method is to calculate a maximum consumption amount consumed per unit time, in which the maximum number of virtual game balls 208 that can be fired per unit time, the selected exchange rate, and a base are used for calculation. The base is the number of prize balls that can be obtained when 100 virtual game balls 208 are fired during the regular game (normal time). For example, when 100 virtual game balls 208 are shot, if the number of possible prize balls is 30, the base is “30”. Further, the number of prize balls that can be acquired as a base is not guaranteed, and may be an index based on a setting value, an experience value, an average value in past games, and the like.

In this case, the maximum consumption amount can be calculated as follows:

Maximum consumption amount=Maximum number of virtual game balls 208 that can be fired per unit time×Selected exchange rate×(100−Base) %.

For example, if the base is 30, 70 virtual game balls 208 can be fired in 1 minute, the unit time is 10 minutes, and the exchange rate selected is set as HK$2.0 per ball, the number of virtual game balls 208 that can be fired in 10 minutes is 700. Thus, HK$980 (=70 balls×10 minutes×HK$2.0×(100−30) %) is calculated as the maximum consumption amount, which is displayed in the consumption information display region 221.

The base may be considered for the calculation of the maximum consumption amount, or may be calculated by multiplying the maximum number of virtual game balls 208 that can be fired per unit time and the selected exchange rate (together) without taking the base into consideration.

Further, in the game processing unit 32, for the convenience of the player, when a region (guide region) to be aimed by the virtual game ball 208 to be fired is displayed on the virtual board 201, a minimum value of the base in a case where the virtual game ball 208 reaches the guide region may be used when calculating the maximum consumption amount. That is, the calculation may be made as follows:

Maximum consumption amount=Maximum number of virtual game balls 208 that can be fired per unit time×Selected exchange rate×(100−(Minimum value of the base of the guide region displayed on the virtual board 201)) %.

In addition, the minimum value of the base on the virtual board 201 may be used. That is, the calculation may be made as follows:

Maximum consumption amount=Maximum number of virtual game balls 208 that can be fired per unit time×Selected exchange rate×(100−(Minimum value of base on virtual board 201)) %.

The second method of calculating the maximum consumption amount is a method of calculating the maximum consumption amount based on the past performance (the number of balls, the number of games, or the performance per hour). For example, when a maximum of 100 virtual game balls 208 are fired in one minute, the maximum consumption amount per minute is calculated based on the performance of the maximum consumption amount for 100 balls. Alternatively, the maximum consumption amount per unit time (for example, 1 minute) in a predetermined time (for example, the past 10 minutes) is calculated. In this case, a maximum consumption point of the virtual game ball 208 per continuous unit time can be specified and calculated from the record of the number of firing virtual game balls 208 or the maximum number of the virtual game balls 208 allowed to be fired in a predetermined time. For example, when the predetermined time is 10 minutes and the unit time is 1 minute, the maximum consumption point for 100 consecutive balls is extracted and displayed from the ball information record of the past 1000 balls. In the game machine, information such as the order in which each ball is fired, the order in which a prize is won, a winning place, a ball payout, etc. is stored in the storage device 301 as a ball information record.

As a third method of calculating the consumption amount, player's selection or input of the maximum consumption amount per unit time may be received. In this case, the rate for which the rate processing unit 31 receives the setting can be calculated by back-calculation from the maximum consumption amount per unit time selected or input by the player. The calculation method of the rate in that case can be made as follows:

Exchange rate to be calculated=Maximum consumption amount per unit time selected or entered/Maximum number of virtual game balls 208 that can be fired per unit time/(100−Base) %.

The output processing unit 35 encodes the amount information held by the player by a predetermined method by, for example, receiving the pressing of the ticket-out button 5f when the player finishes the game of the digital pachinko machine, and performs a printing process for outputting from the ticket printer 6. In a case where the amount information is encoded and stored in an IC chip instead of being output from the ticket printer 6 on paper, a device for transmitting and receiving information is provided instead of the ticket printer 6, and a mobile phone or an IC card is brought closer to the device so as to store the amount information in the IC chip or the like in contact or non-contact. As a device for transmitting/receiving information, a ticket reader may be used as an R/W device, and a device for reading/writing information may be shared.

Instead of the amount, the output processing unit 35 may encode and output information about the number of virtual game balls 208 and the exchange rate of the virtual game ball 208.

The processes in each of the following embodiments can be appropriately combined, and a part of the processing order can be changed. Further, it is also possible to make appropriate design changes as long as the gist of the invention is not impaired.

### First Embodiment

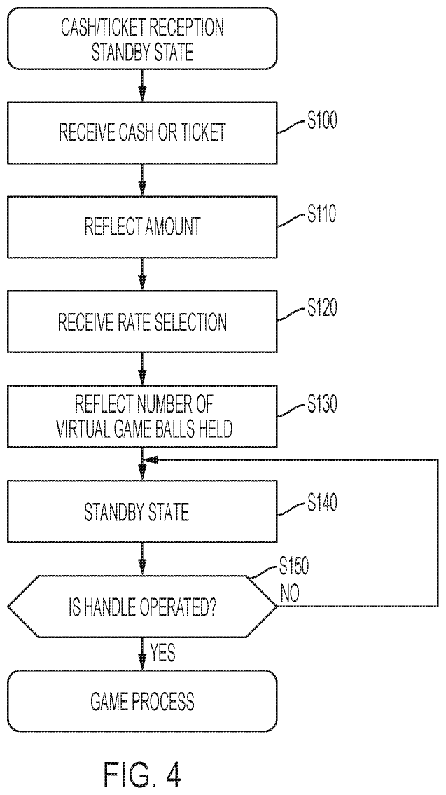

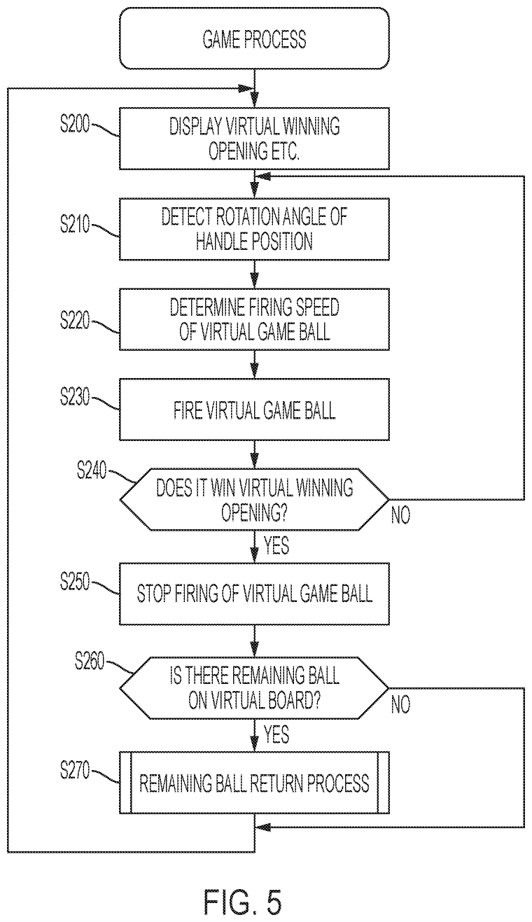

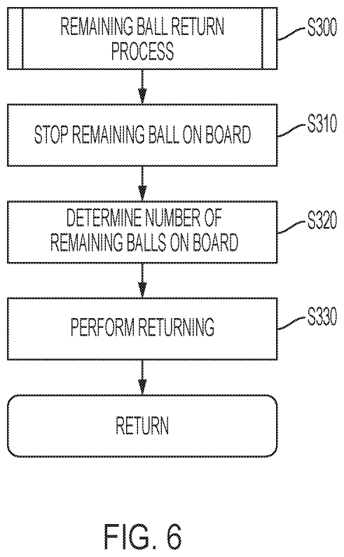

Next, an example of a basic processing process of the game machine of the invention will be described with reference to the flowcharts of FIGS. 4 to 6. FIG. 13 illustrates an example of a display on the display device D of the game machine before a banknote or the like is inserted.

When playing a game (digital pachinko) in the game machine of the invention, a banknote is inserted into a banknote slot or the like which is the amount calculation device 2 (S100). Alternatively, a coin is input into the coin slot which is the amount calculation device 2, or the ticket reader which is the amount calculation device 2, is caused to read the information regarding the encoded amount of money printed on a ticket. Here, for example, it is assumed that one banknote of HK$1,000 is inserted into the banknote slot.

The amount calculation processing unit 30 in the control device 3 reflects the amount as HK$1,000 and stores the amount in the storage device 301 (S110), based on the information regarding the coin input, the inserted banknote, or the read amount of money (HK$1,000) in S100. In the above example, since one HK$1,000 banknote is inserted into the banknote slot, the amount calculation processing unit 30 reflects the amount as HK$1,000.

After reflecting the amount, the rate processing unit 31 receives the selection of the exchange rate of the virtual game ball 208 selected by the rate selection unit (rate selection buttons 5a to 5d) in the rate processing unit 31 (S120). Then, the game processing unit 32 calculates and reflects the number of virtual game balls 208 held based on the amount to be exchanged and the exchange rate (S130). For example, the amount is HK$1,000, and there are four types of the exchange rates: HK$0.2/ball, HK$0.6/ball, HK$1.0/ball, HK$2.0/ball. When the rate selection button (for example, 5a) for the exchange rate of HK$0.2/ball is pressed, the rate processing unit 31 receives the information of the exchange rate, and based on the information, the game processing unit 32 reflects 5,000 virtual game balls 208 as balls held on the storage device 301.

In the rate processing unit 31, by receiving the pressing of the rate selection buttons 5a to 5d at any timing including during the game, the game processing unit 32 can calculate the number of virtual game balls 208 held, and reflect the number appropriately in response to the exchange rate of the virtual game ball 208 for which the selection is received. That is, the game processing unit 32 determines the amount at the timing when the pressing of the rate selection buttons 5a to 5d is received, updates the number of virtual game balls 208 based on the amount and the exchange rate corresponding to the pressed rate selection buttons 5a to 5d, and reflects the number of balls to the storage device 301 as balls held.

When the number of virtual game balls 208 held is reflected as described above, the game processing unit 32 monitors the operation of the handle 4 and waits until the operation of the handle 4 is detected (S140, S150). Before or in parallel with the above-mentioned process, or after reflecting the number of virtual game balls 208 held, the game processing unit 32 displays the virtual board 201, the virtual nail 203, the virtual windmill 204, the virtual winning opening 205, the virtual out opening 206, and the like in the game region 200 (S200). Then, when the game processing unit 32 detects an operation of rotating the handle 4 in a predetermined direction, the game processing unit 32 starts the process of a pachinko game. That is, the game processing unit 32 detects the rotation angle of the position of the handle 4 (S210), and determines the firing speed of the virtual game ball 208 based on the detected rotation angle (S220). As a method of determining the firing speed of the virtual game ball 208 based on the rotation angle of the position of the handle 4, various known methods can be used.

Then, the game processing unit 32 fires the virtual game ball 208 toward the virtual board 201 at the determined firing speed (S230), and the virtual game ball 208 moves along the virtual rail 202 and then moves downward from above on the virtual board 201. FIG. 14 schematically illustrates an example of a screen in a state where the virtual game ball 208 moves on the virtual board 201 in the game processing unit 32. When the handle 4 continues to be rotated from the initial position, the virtual game ball 208 is fired toward the virtual board 201 at predetermined intervals, for example, every one second.

The virtual game ball 208 moves downward while colliding with the virtual nail 203, the virtual windmill 204, and the like on the virtual board 201, and the coordinate position of the virtual game ball 208 is compared with the coordinate of the virtual winning opening 205 or the virtual out opening 206. When it is determined that the coordinate position of the virtual game ball 208 is included in the range of the virtual winning opening 205, it is determined that the virtual game ball 208 has won the virtual winning opening 205 (S240). On the other hand, when the coordinate position of the virtual game ball 208 is included in the range of the virtual out opening 206, the virtual game ball 208 is collected. That is, the virtual game ball 208 is erased from the virtual board 201. FIG. 15 schematically illustrates an example of the screen state immediately before it is determined that the virtual game ball 208 has won the virtual winning opening 205.

Further, the game processing unit 32 updates the ball information record about the virtual game ball 208 stored in the storage device 301.

When it is determined that the virtual game ball 208 has won the virtual winning opening 205, the game processing unit 32 stops the firing process of the virtual game ball 208 (S250). That is, even when the handle 4 of the game machine is rotating, the virtual game ball 208 is not fired. Further, the game processing unit 32 regards, as prize balls, the number of virtual game balls 208 set in the virtual winning opening 205 in which the virtual game balls 208 have won, adds the number of virtual game balls 208 acquired as prize balls to the virtual game balls 208 held by the player stored in the storage device 301, and stores the number of virtual game balls 208 after the addition in the storage device 301. Further, the game processing unit 32 multiplies the number of prize balls to be won (for example, 50) by the exchange rate (for example, HK$0.2), adds the multiplied value to the amount stored in the storage device 301, and newly stores the resultant value as the amount. Then, the game processing unit 32 determines whether another virtual game ball 208 remains on the virtual board 201, that is, whether there is a remaining ball (S260). The determination process of whether there is a remaining ball can be made by determining whether the coordinates of the virtual game ball 208 are within the range of the coordinates of the virtual board 201.

In addition, when the virtual game ball 208 has won the virtual winning opening 205, the game processing unit 32 may perform a predetermined effect indicating that the prize has been won on the display device D. For example, a special screen for notifying the winning illustrated in FIG. 16 may be displayed.

Then, when the game processing unit 32 determines that the virtual game ball 208 is present on the virtual board 201, the return processing unit 33 is caused to perform the return process of the remaining balls and the amount corresponding to the number of the remaining balls (S270, S300).

The return processing unit 33 stops the movement of the remaining balls on the virtual board 201, and determines the number of the remaining balls (S310, S320). In this case, the number of virtual game balls 208 within the range of the virtual board 201 may be counted based on the coordinates of the virtual game ball 208, or if the game processing unit 32 manages the number of virtual game balls 208 in the virtual board 201 using a variable or the like, the number may be determined by counting the number of the variables. Then, the return processing unit 33 adds the determined number to the number of virtual game balls 208 held at that time, which is stored in the storage device 301, and executes the return process of the number of virtual game balls 208 held (S330). The return processing unit 33 also multiplies the determined number by the exchange rate, and calculates the amount corresponding to the determined number. Then, by adding the calculated value to the amount stored at that time in the storage device 301, the return process of the amount corresponding to the remaining ball is performed.

After performing the return process of the remaining balls and the corresponding amount in the return processing unit 33 as described above, the virtual winning opening 205 and the like are displayed on the display device D, and if the handle 4 is rotated, that is, the detection process of the rotation angle of the position of the handle 4 is performed, the game machine returns to the game.

When the player desires to end the game, the player stops operating the handle 4 of the game machine, and the handle 4 returns to the initial position (S150). Then, the game processing unit 32 waits until the virtual game balls 208 on the virtual board 201 are removed, and after all the virtual game balls 208 are removed from the virtual board 201, the player only has to leave the seat as it is if there is no remaining amount.

On the other hand, when there is a remaining amount, to carry over the amount in preparation for the next game, the player performs an operation such as pressing the button 5f or the like that outputs a predetermined ticket provided on the game machine, and the output processing unit 35 receives the input by the operation. Then, the output processing unit 35 determines the amount information of the player at the end time stored in the storage device 301. Then, this information is encoded, and printed out on a ticket. In addition to printing out on a ticket, if the ticket is not a paper but an electronic medium, the amount information of the player at the time of termination may be stored in the mobile phone, an IC memory of the IC card, or the like used by the player. By performing such an output process, the information about the number of possessed balls stored in the storage device 301 is set to zero.

By performing such output processing, the player can carry forward and enjoy the amount of the previous game as it is when the player enjoys the game with the game machine next time.

The game in the game machine is executed by the above processes. Next, the processing of information regarding the display of the consumption amount displayed in the consumption information display region 221 of the screen displayed on the display device D by the game processing unit 32 will be described. Further, the process relating to the display of the consumption amount is executed in parallel with each of the above-mentioned processes.

A case where the consumption information processing unit 34 uses the first calculation method will be described. In this case, the consumption information processing unit 34 calculates the maximum consumption amount consumed per unit time, based on the information of the maximum number of virtual game balls 208 that can be fired per unit time, the selected exchange rate and the base which are stored in the storage device 301, as follows:

Maximum consumption amount=Maximum number of virtual game balls 208 that can be fired per unit time×Selected exchange rate×(100−Base) %.

Then, the calculated maximum consumption amount is displayed in the consumption information display region 221. “HK$980” illustrated in FIG. 13 is a display example when “HK$980” is calculated as an example of the maximum consumption amount.

### Second Embodiment

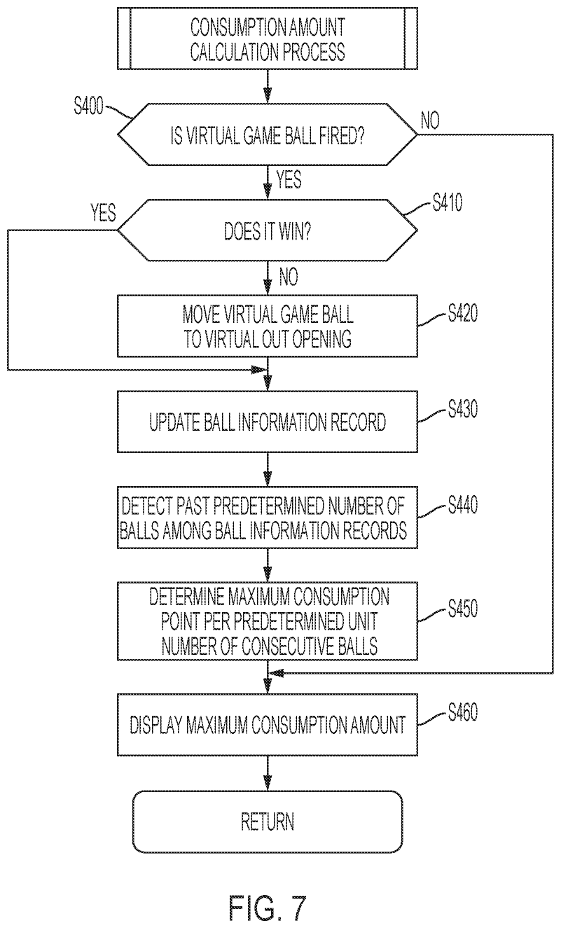

Next, a case where the consumption information processing unit 34 uses the second calculation method will be described. An example of the processing process of the consumption information processing unit 34 in this case will be described with reference to the flowchart of FIG. 7.

When the game processing unit 32 detects the rotation of the handle 4, the rotation angle of the position of the handle 4 is detected, and the firing speed of the virtual game ball 208 is determined based on the detected rotation angle. Then, the game processing unit 32 shoots the virtual game ball 208 toward the virtual board 201 at the determined firing speed (S400), and the virtual game ball 208 moves along the virtual rail 202 and then moves downward from above on the virtual board 201.

The virtual game ball 208 moves downward while colliding with the virtual nails 203, the virtual windmills 204, and the like on the virtual board 201, and the coordinate position of the virtual game ball 208 is compared with the coordinate of the virtual winning opening 205 or the virtual out opening 206. When it is determined that the coordinate position of the virtual game ball 208 is included in the range of the virtual winning opening 205, it is determined that the virtual game ball 208 has won the virtual winning opening 205 (S410). On the other hand, when the coordinate position of the virtual game ball 208 is included in the range of the virtual out opening 206, the virtual game ball 208 is collected (S420).

Then, the game processing unit 32 updates the ball information record about the virtual game ball 208 stored in the storage device 301 (S430).

The consumption information processing unit 34 detects, from the storage device 301, a past predetermined number of balls, for example, the ball information record of 1,000 balls among the ball information records stored in the storage device 301 (S440), and determines a predetermined unit number of consecutive balls, for example, the maximum consumption point for any group of 100 balls (S450). That is, in any group of the 100 consecutive balls, the portion with the highest consumption amount is determined, and displayed in the consumption amount display processing unit as the maximum consumption amount (S460).

If the virtual game ball 208 is not fired, for example, before starting the game, or when the handle 4 is not rotated even during the game, the maximum consumption amount already determined may be displayed.

By executing the above process, the maximum consumption amount can be calculated based on the past performance.

### Third Embodiment

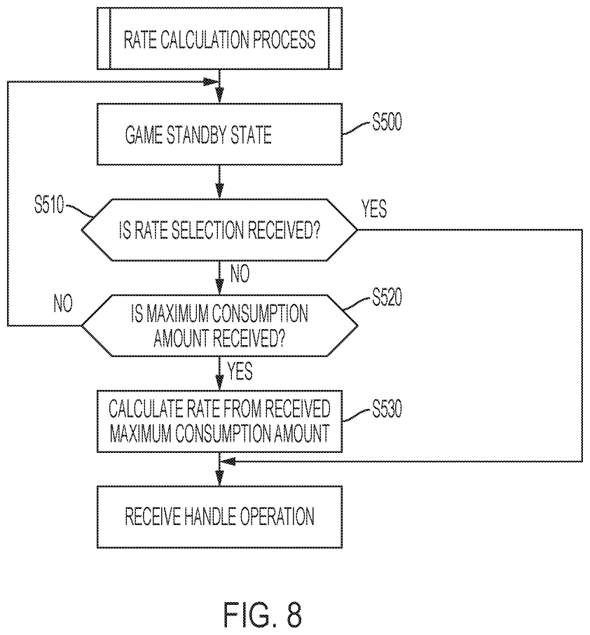

Next, unlike the first and second embodiments, the consumption information processing unit 34 may receive the input of the maximum consumption amount per unit time by receiving a predetermined selection or input operation in the game machine. In this case, the rate may be calculated based on the maximum consumption amount per unit time received by the consumption information processing unit 34. An example of the processing in that case is illustrated in the flowchart of FIG. 8.

First, in the game standby state (S500), if the rate processing unit 31 receives a rate selection (S510), the rate is set as selected.

On the other hand, when the rate processing unit 31 has not received the rate selection (S510), the consumption information processing unit 34 receives the input of the maximum consumption amount per unit time (S520). Then, the rate is calculated backwards based on the received maximum consumption amount (S530). For example, the rate is calculated as follows:

Exchange rate to be calculated=Maximum consumption amount per unit time selected or entered/Maximum number of virtual game balls 208 that can be fired per unit time/(100−Base) %.

When the rate processing unit 31 calculates the rate as described above, the rate is stored as the exchange rate of the amount and the credit, and used in the process in the game.

The processing of this embodiment may be executed when the rate processing unit 31 has received the rate. In that case, the rate received by the rate processing unit 31 and the rate calculated based on the maximum consumption amount conflict, so if the input of the maximum consumption amount is received, the rate is calculated based on the maximum consumption amount per unit time received by the consumption information processing unit 34 instead of the rate received by the rate processing unit 31.

### Fourth Embodiment

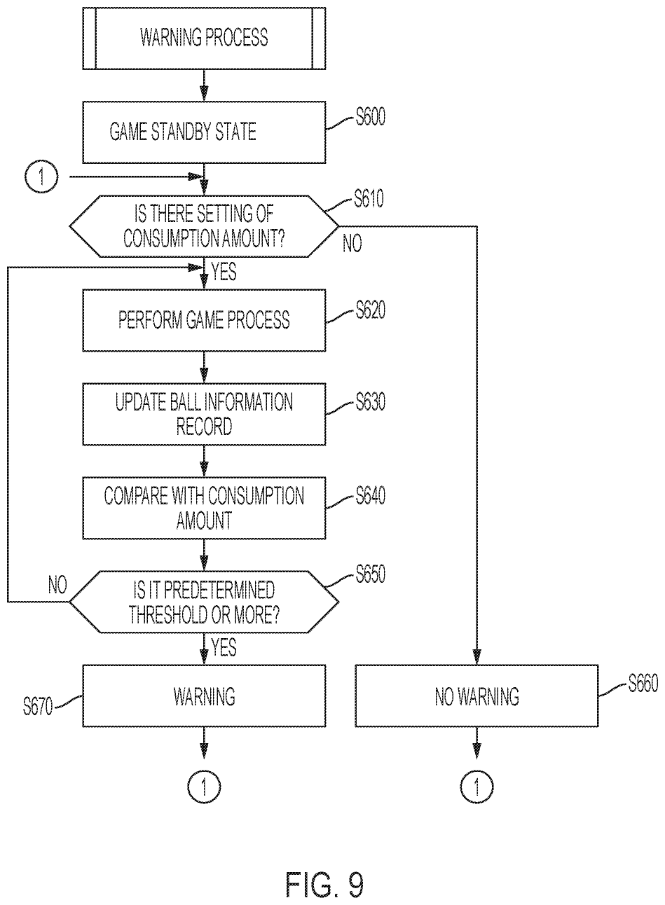

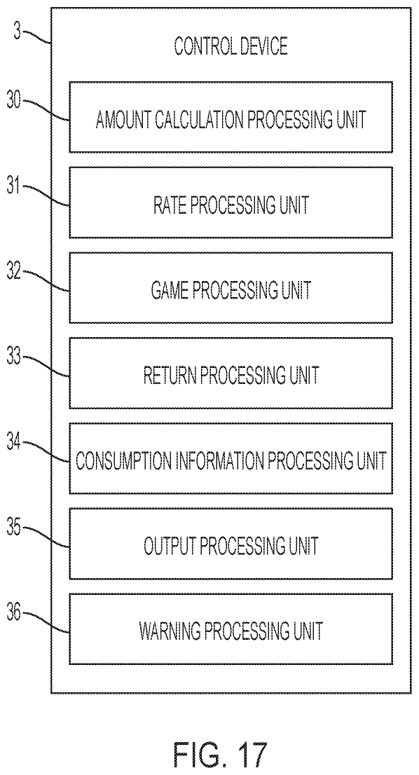

In the game machine of the invention, when a predetermined condition for the consumption amount is satisfied, a predetermined warning process such as a game stop or a warning display may be performed. An example of the processing process in this case is illustrated in the flowchart of FIG. 9. In this case, the control device 3 of the game machine is provided with a warning processing unit 36. The configuration of each function in the control device 3 in this case is illustrated in FIG. 17.

The warning processing unit 36 compares the ball information record stored in the storage device 301 with the consumption amount of the consumption information processing unit 34, and executes a predetermined warning process when a predetermined condition is satisfied.

Next, the process in this embodiment will be described with reference to the flowchart of FIG. 9.

In the game standby state (S600), if the consumption amount is set (S610), the game processing unit 32 executes the game process (S620). That is, when the game processing unit 32 detects the rotation of the handle 4, the rotation angle of the position of the handle 4 is detected, and the firing speed of the virtual game ball 208 is determined based on the detected rotation angle. Then, the game processing unit 32 fires the virtual game ball 208 toward the virtual board 201 at the determined firing speed, and the virtual game ball 208 moves along the virtual rail 202 and then moves downward from above on the virtual board 201.

The virtual game ball 208 moves downward while colliding with the virtual nails 203, the virtual windmills 204, and the like on the virtual board 201, and the coordinate position of the virtual game ball 208 is compared with the coordinate of the virtual winning opening 205 or the virtual out opening 206. When it is determined that the coordinate position of the virtual game ball 208 is included in the range of the virtual winning opening 205, it is determined that the virtual game ball 208 has won the virtual winning opening 205. On the other hand, when the coordinate position of the virtual game ball 208 is included in the range of the virtual out opening 206, the virtual game ball 208 is collected (S420).

Then, the game processing unit 32 updates the ball information record about the virtual game ball 208 stored in the storage device 301 (S630).

Then, the warning processing unit 36 compares the ball information record stored in the storage device 301 with the consumption amount of the consumption information processing unit 34 (S640), and determines whether a predetermined threshold is satisfied, for example, 80% or more of the set consumption amount (S650). If it is not satisfied, the warning is not given and the execution of the game process in the game processing unit 32 is continued (S620).

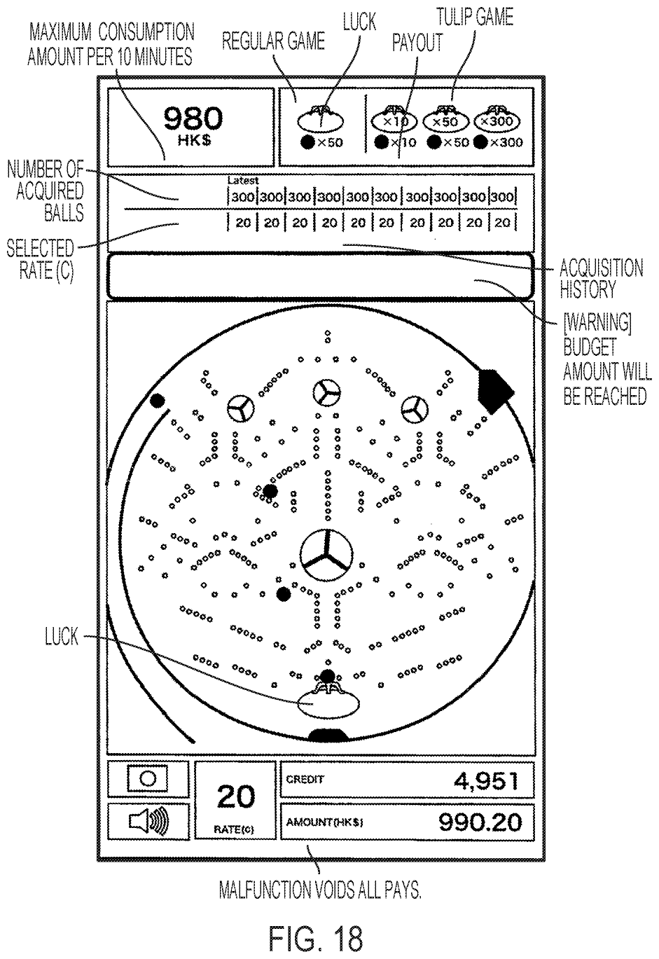

On the other hand, when the predetermined threshold is satisfied, the warning processing unit 36 displays a warning message such as “Warning! Budget amount will be reached” on a predetermined portion of the display device D, for example, the virtual board 201 (S670). FIG. 18 illustrates an example of the display on the display device D in this state.

The warning message displayed by the warning processing unit 36 may be temporarily displayed or may be permanently displayed.

Further, a plurality of predetermined thresholds for use in the comparison with the consumption amount may be set, and a warning message in the warning processing unit 36 may be displayed when each of the stages such as 80%, 100% and 120% of the consumption amount is reached.

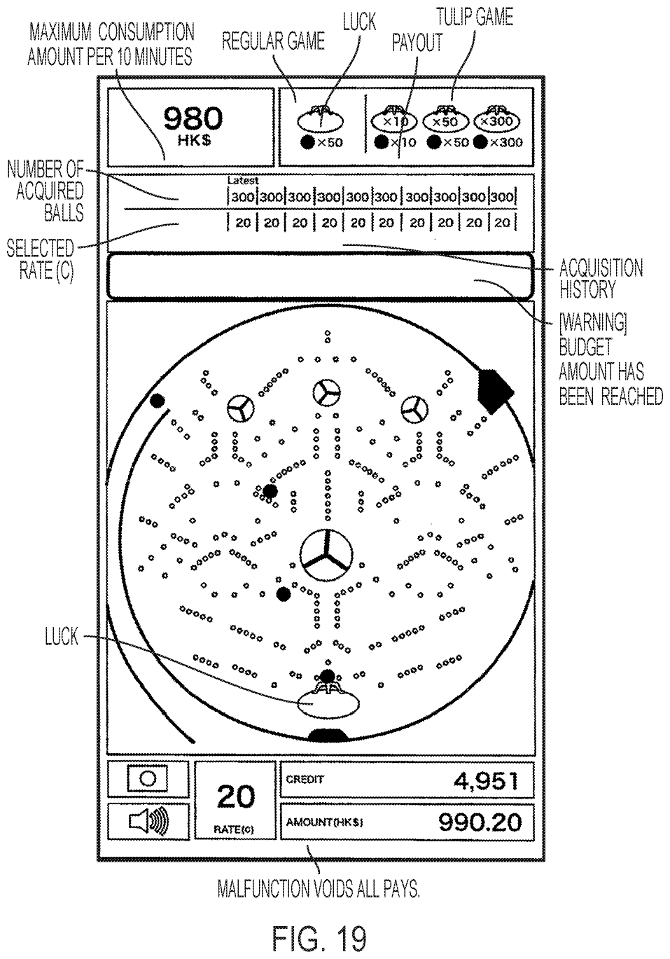

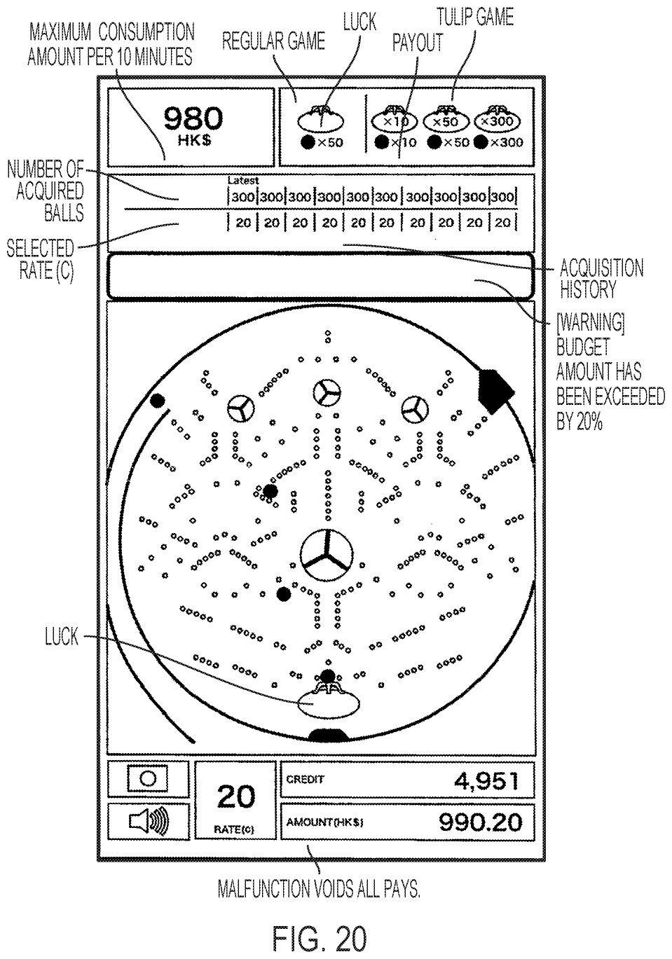

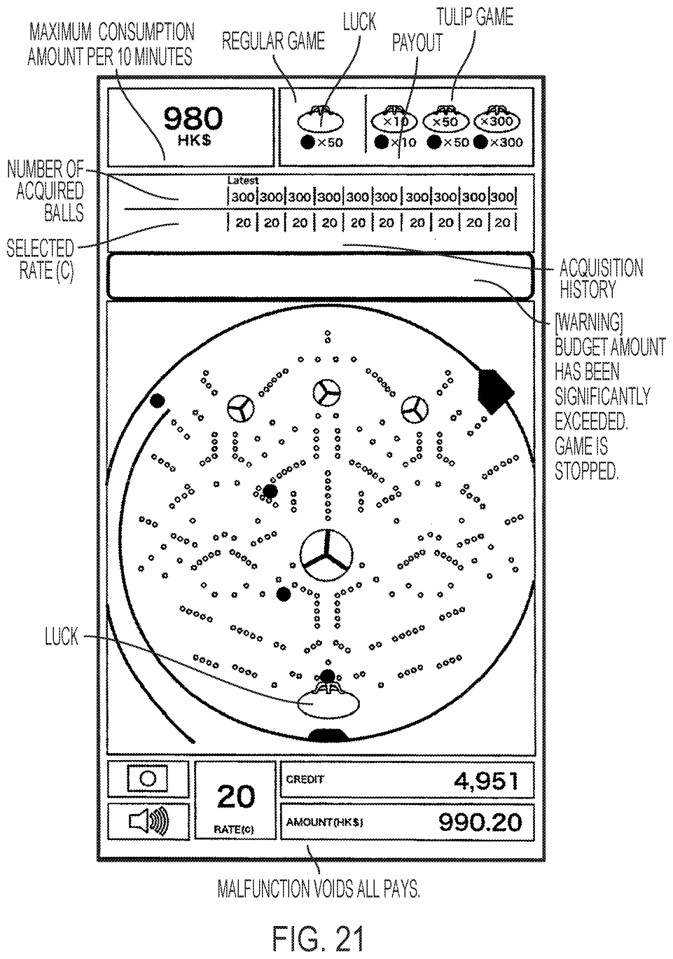

The warning processing unit 36 may change the content of the warning message displayed at each stage. For example, when 80% of the consumption amount is reached, “Warning! Budget amount will be reached”, when 100% of the consumption amount is reached, “Warning! Budget amount has been reached” (FIG. 19), and when it reaches 120% of the consumption amount, a message such as “Warning! Budget amount has been exceeded by 20%” (FIG. 20) may be displayed. In addition, when the consumption amount is exceeded, the warning message may indicate the percentage of excess. Furthermore, the warning processing unit 36 may display a warning message such as “Budget amount is significantly exceeded. The game is stopped” (FIG. 21) when the consumption amount exceeds a certain amount, for example, 125% or 150% of the consumption amount is reached, information for stopping the game is passed to the game processing unit 32, and the game processing unit 32 receiving the information may stop the processing of the game.

### Fifth Embodiment

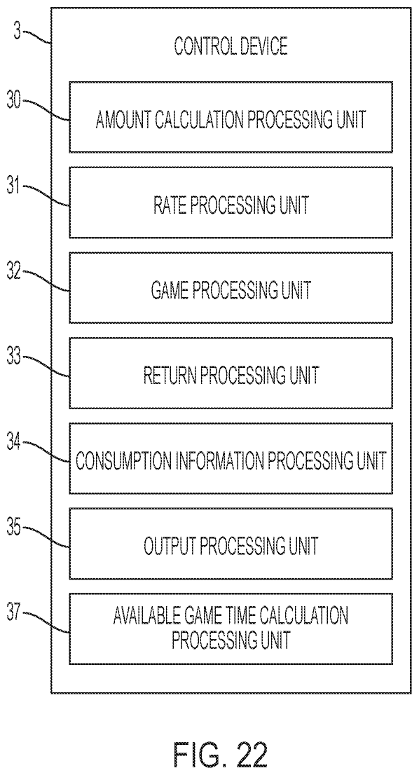

In the game machine of the invention, an available game time may be displayed according to the amount input by the player or the amount or credit at a certain time point. The available game time in this case is the shortest available game time or the average available game time. In this case, the control device 3 of the game machine is provided with an available game time calculation processing unit 37. The configuration of each function in the control device 3 in this case is illustrated in FIG. 22.

The shortest available game time is calculated by the available game time calculation processing unit 37, based on the maximum number of virtual game balls 208 that can be fired per unit time, the amount of the player, and the rate. That is, the calculation is made as follows:

Shortest available game time=Amount/Rate/Maximum number of virtual game balls 208 that can be fired per unit time.

The available game time calculation processing unit 37 only has to display the calculated available game time in the display region provided in a predetermined region of the display device D as a display region of the available game time.

For example, if the maximum number of virtual game balls 208 that can be fired per minute is 100 in the game machine, and if the amount is HK$1,000 and the rate is HK$2.0, 5 minutes is calculated as the shortest available game time.

Further, in order to calculate the average available game time by the available game time calculation processing unit 37, it is calculated based on the ball payout ratio (return rate), the amount of the player, and the rate. That is, the calculation is made as follows:

Average available game time=Amount/Rate/(Maximum number of virtual game balls 208 that can be fired per unit time×(1−Ball payout ratio)).

For example, if the maximum number of virtual game balls 208 that can be fired per minute is 100 in the game machine, the ball payout ratio is 90% (=0.9), the amount is HK$1,000, and the rate is HK$2.0/ball, 50 minutes is calculated as the average available game time.

The game processing unit 32 may control so that the game processing unit 32 does not detect the rotation of the handle 4 unless the player confirms the available game time and presses a predetermined operation, for example, pressing the button 5 or the like.

### Sixth Embodiment

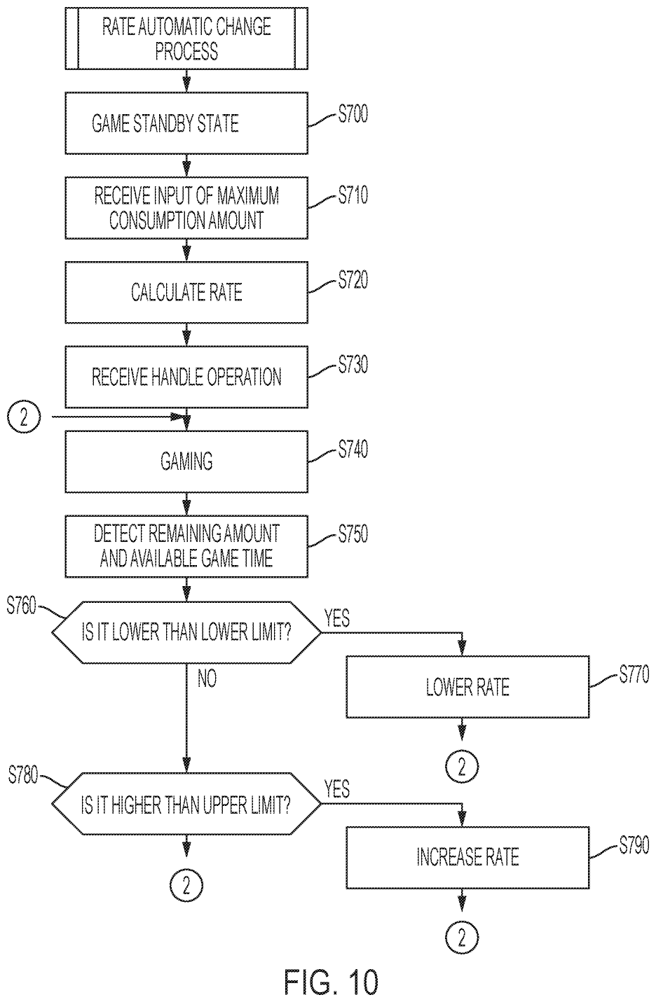

Further, as another embodiment of the game machine of the invention, the rate processing unit 31 may automatically change the rate during the game so that the maximum consumption amount per unit time preset by the player is reached. An example of the process in this case will be described with reference to the flowchart of FIG. 10.

First, in the game standby state (S700), the consumption information processing unit 34 receives the input of the maximum consumption amount by the player (S710). Then, using the processes of the third embodiment and the like, the rate processing unit 31 calculates backwards the rate based on the received maximum consumption amount (S720). In this way, when the rate processing unit 31 calculates the rate as described above, the rate is stored as the exchange rate of the amount for the credit, and used in the process in the game.

When the game processing unit 32 receives an operation of the handle 4 by detecting the rotation of the handle 4 or the like (S730), the game is started (S740). Then, during the game, t the available game time calculated by the available game time calculation processing unit 37 are detected by the remaining amount stored in the storage device 301 and the fifth embodiment or the like (S750). Then, when determining that it is lower than the lower limit of the predetermined available game time (S760), the rate processing unit 31 performs a process of lowering the rate (S770). For example, the rate is changed from HK$2.0 to HK$1.0.

Further, when determining that it is higher than the upper limit of the predetermined available game time (S780), the rate processing unit 31 performs a process of increasing the rate (S790). For example, the rate is changed from HK$1.0/ball to HK$2.0/ball.

Specifically, it is assumed that the consumption information processing unit 34 has received the input of the maximum consumption amount so that the player can play a game for HK$1,000 for 10 minutes as a unit time, and the rate is HK$2.0/ball. If the prize ball cannot be obtained for the first 2 minutes, the rate processing unit 31 determines that the player can only play the game for the remaining 3 minutes (determining that it is below the lower limit), and changes the rate to HK$1.0/ball.

By repeating the above process, the player can enjoy the game for the set amount of money and the set amount of time.

### Seventh Embodiment

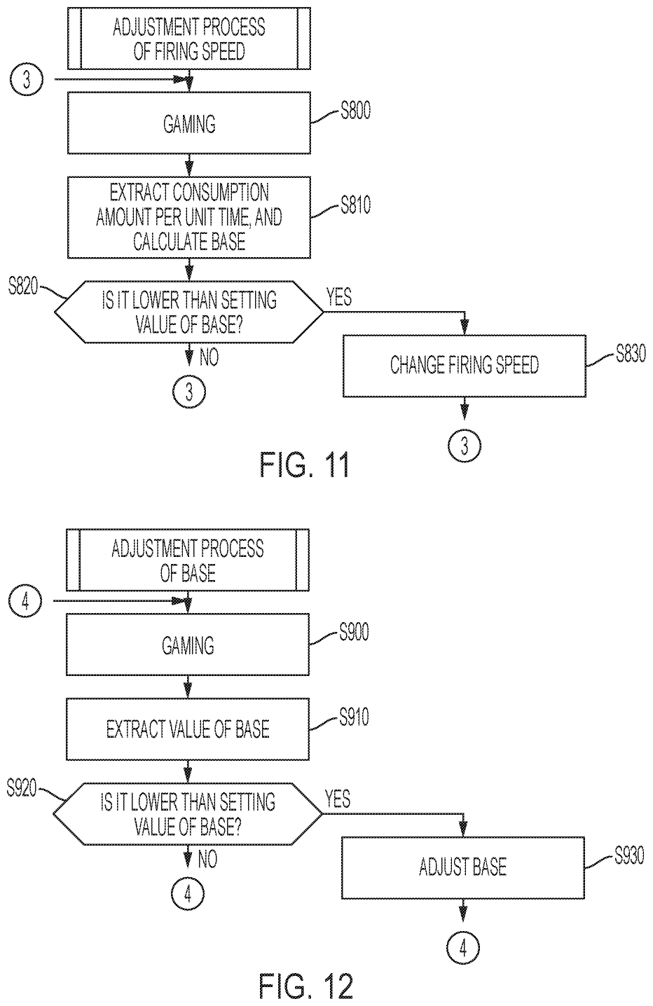

The game processing unit 32 may change the firing speed of the virtual game ball 208 so that the displayed maximum consumption amount per unit time is reached, and may arrange for the maximum consumption amount per unit time not to be exceeded. An example of the process in this case is illustrated in the flowchart of FIG. 11.

While executing the game processing in the game processing unit 32 (S800), the game processing unit 32 extracts the consumption amount per unit time (for example, 1 minute) set in advance (S810). For example, in a game machine capable of firing 100 virtual game balls 208 per minute, if the rate is HK$2.0/ball, the base is 50, and the maximum consumption amount per 10 minutes is HK$1,000, the consumption amount is extracted at the time of passing the unit time (1 minute).

Then, when the base value calculated from the extracted consumption amount per unit time has fallen below the preset base value (50) (S820), the game processing unit 32 changes the firing speed of the virtual game ball 208 (S830). For example, if the consumption amount of HK$100 or more per minute as the unit time is extracted, the firing speed of the virtual game ball 208 is changed to be slow down since the base value is below 50.

By performing the above process every predetermined unit time (for example, 1 minute), it is possible to make adjustment so as not to exceed the maximum consumption amount for a preset time (for example, 10 minutes).

### Eighth Embodiment

The game processing unit 32 may change the base so that the displayed maximum consumption amount per unit time is reached, and adjustment may be performed so that the maximum consumption amount per unit time is not exceeded. An example of the processing process in this case is illustrated in the flowchart of FIG. 12. In this case, the game processing unit 32 does not change the ball payout ratio (return rate) to the player, so the selection probability of the jackpot (more prize balls can be acquired than usual) or the number of prize balls at the time of the jackpot is adjusted.

While the game processing unit 32 is performing the game process (S900), the game processing unit 32 extracts the actual base value (S910). Then, when the game processing unit 32 determines that the value is below the lower limit of the setting value of the base (S920), the base adjustment process (changing the number of prize balls when entering the winning opening, etc.) is performed. However, in that case, in order not to change the ball payout ratio (return rate), the game processing unit 32 executes a control process such as changing the number of prize balls at the time of the jackpot or changing the selection probability of the jackpot.

For example, in a game machine with a ball payout ratio of 90%, if the ball payout ratio set as the basic design value is 20% at a normal time and 70% at the time of the jackpot, the game processing unit 32 adjusts (increases) the number of prize balls when entering the winning opening so that the base of the regular game (normal time) becomes 30 if the base for the regular game (normal time) is less than 20 and moves at 10. However, when the base of the regular game (normal time) is adjusted to 30, the jackpot selection probability and/or the ball payout in the jackpot is changed (decreased) so that the ball payout ratio in the jackpot is 60%, and the ball payout ratio of the game machine is always 90%.

By performing the above process in every predetermined unit time, it is possible to make adjustment so as not to exceed the maximum consumption amount for a preset time (10 minutes).

### INDUSTRIAL AVAILABILITY

With the game machine of the invention, it is possible to eliminate anxiety about money consumption when a player plays a game on the game machine.

### REFERENCE SIGNS LIST

1 casing

2 amount calculation device

3 control device

4 handle

5 button unit

5a to 5d rate selection button (rate selection unit)

5e language selection button

5f ticket out button

5g volume adjustment button

5h button to display the game explanation screen (help button)

5i button to display tutorial

5j, 5k spare button

5l button to call a clerk

6 ticket printer

30 amount calculation processing unit

31 rate processing unit

32 game processing unit

33 return processing unit

34 consumption information processing unit

35 output processing unit

36 warning processing unit

37 available game time calculation processing unit

200 game region

201 virtual board

202 virtual rail

203 virtual nail

204 virtual windmill

205 virtual winning opening

206 virtual out opening

208 virtual game ball

210 amount display region

211 credit display region

212 selected rate display region

213 selected language display region

214 sound output selection region

220 acquisition history display region

221 consumption information display region

222 payout display region

300 arithmetic device

301 storage device

302 input/output interface

303 communication interface

D display device

SP speaker

1. A game machine having a display device in a casing, comprising:
a game processing unit that performs a game process; and
a consumption information processing unit that displays consumption information for the game on the display device.

2. The game machine according to claim 1,
wherein the consumption information processing unit calculates maximum consumption information per unit time and displays the maximum consumption information on the display device.

3. The game machine according to claim 2,
wherein the consumption information processing unit calculates the maximum consumption information per unit time using a maximum number of virtual game balls that can be fired per unit time and an exchange rate.

4. The game machine according to claim 1,
wherein the consumption information processing unit calculates maximum consumption information based on a past performance, and displays the maximum consumption information on the display device.

5. The game machine according to claim 4,
wherein the consumption information processing unit calculates the maximum consumption information by specifying a maximum consumption point of virtual game balls per continuous unit time from a record of the number of fired virtual game balls in a predetermined time among ball information records in the game machine.

6. The game machine according to claim 1,
wherein the consumption information processing unit receives maximum consumption information selected or input by a player, and displays the maximum consumption information on the display device.

7. The game machine according to claim 1, further comprising:
a warning processing unit that performs a predetermined control process when a predetermined condition for the consumption information is satisfied.

8. The game machine according to claim 7,
wherein the warning processing unit displays a warning message on the display device as the predetermined control process.

9. The game machine according to claim 7,
Wherein the warning processing unit has a plurality of thresholds, and when an amount or credit in the game machine satisfies a condition for each threshold, the warning processing unit displays different warning messages on the display device as the predetermined control process.

10. The game machine according to claim 7,
wherein the warning processing unit stops a game in the game machine as the predetermined control process.

11. The game machine according to claim 1, further comprising:
an available game time calculation processing unit that displays an available game time according to an amount or credit of a player.

12. The game machine according to claim 11,
wherein the available game time calculation processing unit calculates the available game time using a maximum number of virtual game balls that can be fired per unit time, an exchange rate, and an amount.

13. The game machine according to claim 11,
wherein the available game time calculation processing unit calculates the available game time using a ball payout ratio, a maximum number of virtual game balls that can be fired per unit time, an exchange rate, and an amount.

14. The game machine according to claim 11,
wherein when the available game time calculated by the available game time calculation processing unit satisfies a predetermined condition for the available game time, the exchange rate is changed using maximum consumption information.

15. The game machine according to claim 1,
wherein when consumption information per predetermined unit time satisfies a predetermined condition, the game processing unit changes a firing speed of a virtual game ball so as not to exceed the consumption information in the consumption information processing unit.

16. The game machine according to claim 1,
wherein when a base satisfies a predetermined condition, the game processing unit changes a base setting so as not to exceed the consumption information in the consumption information processing unit.
